(19) United States
(12) Patent Application Publication
(10) Pub. No.: US 2022/0255970 A1
(43) Pub. Date: Aug. 11, 2022

(54) Deploying And Maintaining A Trust Store To Dynamically Manage Web Browser Extensions On End User Computing Devices

(71) Applicant: Bank of America Corporation, Charlotte, NC (US)

(72) Inventors: Stuart David Ford, Slapton (GB); Andrew Paul Montgomery, London (GB); Sanjay Bhanu, Camberley (GB); Ricardo Varanda, Reading (GB)

(21) Appl. No.: 17/172,652

(22) Filed: Feb. 10, 2021

(51) Int. Cl. H04L 29/06

(52) U.S. Cl. CPC H04L 63/205; H04L 63/308; H04L 63/306; H04L 63/10

(57) ABSTRACT

Aspects of the disclosure relate to deploying and maintaining a trust store to dynamically manage web browser extensions on end user computing devices. In some embodiments, an end user computing device may receive a user request to access resources located outside of the enterprise computing infrastructure. The end user computing device may extract and collect user attributes, system attributes, and request attributes from the user request, and deliver the attributes to an enterprise computing platform. The enterprise computing platform may evaluate the attributes to generate a trust score and rules. The enterprise computing platform may deliver the trust score and the rules to the web browser extension associated with the end user computing device. The web browser extension may analyze the trust score using the rules generated by the enterprise computing platform to either grant or deny the user request.

### BACKGROUND

Aspects of the disclosure relate to hardware and software for deploying and maintaining a trust store to dynamically manage web browser extensions on end user computing devices. In particular, one or more aspects of the disclosure relate to generating a trust score and evaluating the trust score to determine whether to allow or to deny a user request.

Enterprise organizations may utilize various computing infrastructure to maintain confidential information and/or other sensitive data that is created and/or used for various purposes. Ensuring that this data is secure and only accessible to appropriate users for appropriate purposes may be critically important to protecting the integrity and confidentiality of the underlying information and associated resources. In many instances, it may be difficult to ensure the security and integrity of enterprise-managed information and resources, particularly when also attempting to optimize the resource utilization, bandwidth utilization, and efficient operations of the enterprise computing infrastructure.

### SUMMARY

Aspects of the disclosure provide effective, efficient, scalable, and convenient technical solutions that address and overcome the technical problems associated with ensuring information security and preventing unauthorized access to enterprise resources by deploying and maintaining a trust store to dynamically manage web browser extensions on end user computing devices.

In accordance with one or more embodiments, an end user computing device having at least one processor, a communication interface, a display device, and memory may receive, via the communication interface, a user request to access resources located outside of the enterprise computing infrastructure. In response to receiving a user request to access resources located outside of the enterprise computing infrastructure, the end user computing device may extract user attributes, system attributes, and request attributes from the user request. An enterprise computing platform having at least one processor and memory may receive the user attributes, system attributes, and request attributes that were extracted from the user request. The enterprise computing platform may evaluate the user attributes, system attributes, and request attributes from the user request to generate a trust score and rules. The enterprise computing platform may deliver the trust score and the rules to the web browser extension associated with the end user computing device. The web browser extension may analyze the trust score using the rules received from the enterprise computing platform to determine whether to grant or to deny the user request to access resources located outside of the enterprise computing infrastructure.

In some embodiments, the web browser extension, upon evaluation of the trust score and the rules, may grant the user request to access resources located outside of the enterprise computing infrastructure. In response to granting the user request to access resources located outside of the enterprise computing infrastructure, the requested resources may be displayed on a display device of the end user computing device such that the user may interact with the requested resources using the display device.

In some embodiments, the web browser extension, upon evaluation of the trust score and the rules, may deny the user request to access resources located outside of the enterprise computing infrastructure. In response to denying the user request to access resources located outside of the enterprise computing infrastructure, the web browser extension may generate an error message to inform the user that the requested resources cannot be accessed. The error message generated by the web browser extension may be displayed on the display device of the end user computing device.

These features, along with many others, are discussed in greater detail below.

### BRIEF DESCRIPTION OF THE DRAWINGS

The present disclosure is illustrated by way of example and is not limited in the accompanying figures in which like reference numerals indicate similar elements and in which:

FIG. 1A depicts an illustrative computing environment for deploying and maintaining a trust store to dynamically manage web browser extensions on end user computing devices in accordance with one or more example embodiments;

FIG. 1B depicts an illustrative enterprise computing platform for deploying and maintaining a trust store to dynamically manage web browser extensions on end user computing devices in accordance with one or more example embodiments;

FIG. 1C depicts an illustrative end user computing device for deploying and maintaining a trust store to dynamically manage web browser extensions on end user computing devices in accordance with one or more example embodiments; and

FIGS. 2A-2E depict an illustrative event sequence for deploying and maintaining a trust store to dynamically manage web browser extensions on end user computing devices in accordance with one or more example embodiments.

### DETAILED DESCRIPTION

In the following description of various illustrative embodiments, reference is made to the accompanying drawings, which form a part hereof, and in which are shown, by way of illustration, various embodiments in which aspects of the disclosure may be practiced. It is to be understood that other embodiments may be utilized, and structural and functional modifications may be made, without departing from the scope of the present disclosure.

It is noted that various connections between elements are discussed in the following description. It is noted that these connections are general and, unless specified otherwise, may be direct or indirect, wired or wireless, and that the specification is not intended to be limiting in this respect.

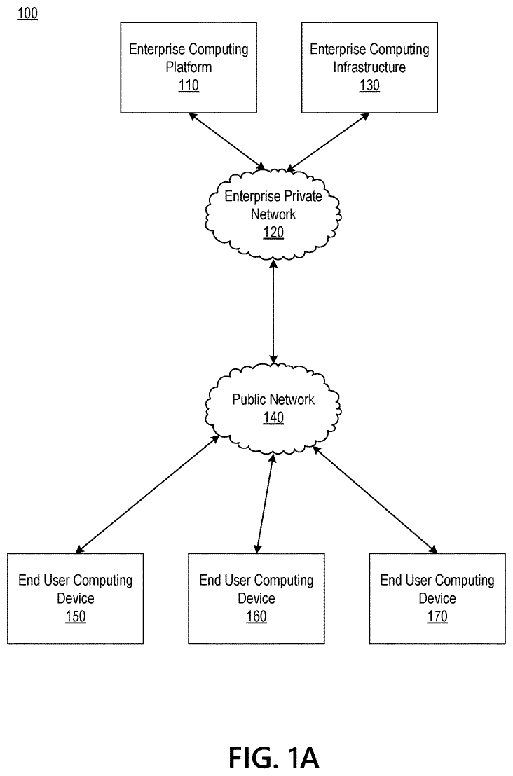

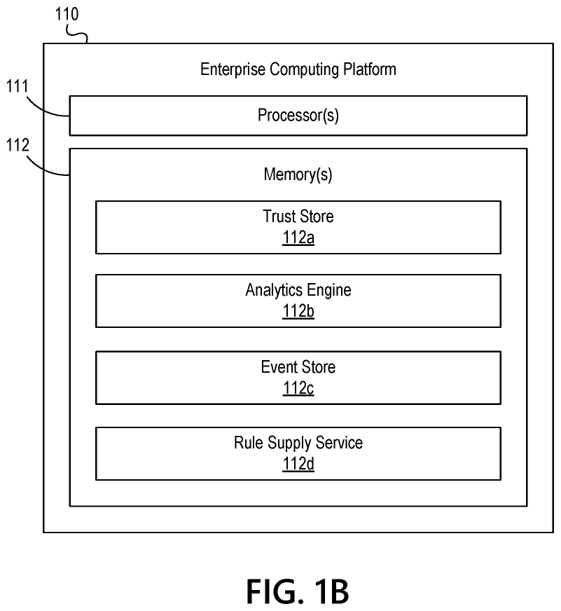

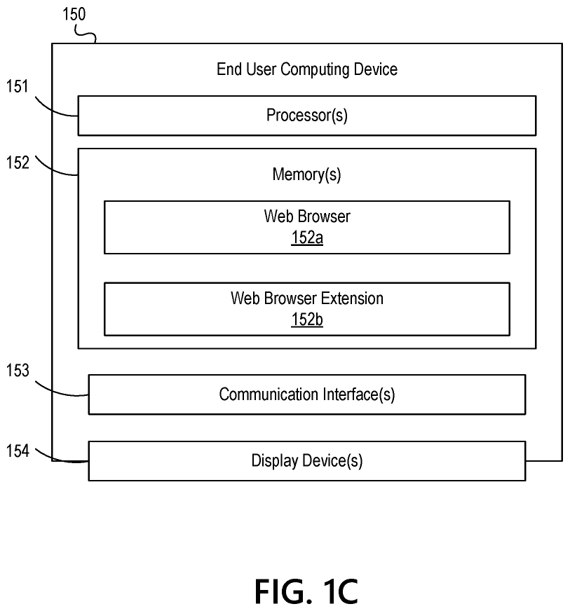

FIG. 1A depicts an illustrative computing environment for deploying and maintaining a trust store to dynamically manage web browser extensions on end user computing devices in accordance with one or more example embodiments. Referring to FIG. 1A, computing environment 100 may include one or more computer systems and networks. For example, computing environment 100 may include an enterprise computing platform 110, an enterprise private network 120, enterprise computing infrastructure 130, a public network 140, a first end user computing device 150, a second end user computing device 160, and a third end user computing device 170.

As discussed in greater detail below in connection with FIG. 1B, enterprise computing platform 110 may include one or more processor(s) 111 and memory(s) 112. Memory 112 may include a trust store 112a, an analytics engine 112b, an event store 112c, and a rule supply service 112d. Memory 112 may be configured to perform one or more of the functions described herein.

Enterprise computing infrastructure 130 may include one or more computing devices and/or other computer components (e.g., processors, memories, communication interfaces). In addition, enterprise computing infrastructure 130 may be configured to receive information from, send information to, and/or otherwise exchange information with one or more enterprise devices.

End user computing device 150 may include one or more computing devices and/or other computer components (e.g., processors, memories, communication interfaces, display devices). End user computing device 150 may be a mobile computing device (e.g., smartphone, tablet, laptop computer, or the like). In addition, end user computing device 150 may be linked to and/or used by a user (who may, e.g., be an employee or other individual authorized to access enterprise resources). End user computing device 160 and end user computing device 170 may contain features identical to those described herein with respect to end user computing device 150. In some instances, end user computing device 160 and end user computing device 170 may be linked to different users (e.g., different from the user of end user computing device 150).

In some arrangements, enterprise computing platform 110 and enterprise computing infrastructure 130 may be owned and/or operated by an enterprise organization. In addition, end user computing device 150, end user computing device 160, and end user computing device 170 may be owned and/or operated by users of the enterprise organization.

Computing environment 100 also may include one or more networks, which may interconnect one or more of enterprise computing platform 110, enterprise computing infrastructure 130, end user computing device 150, end user computing device 160, and end user computing device 170. For example, computing environment 100 may include an enterprise private network 120 (which may, e.g., connect enterprise computing platform 110 and enterprise computing infrastructure 130 and/or other enterprise computing systems). Computing environment 100 may also include a public network 140 (which may, e.g., connect end user computing device 150, end user computing device 160, and end user computing device 170). Enterprise private network 120 and public network 140 may communicate with each other to connect enterprise computing platform 110, enterprise computing infrastructure 130, end user computing device 150, end user computing device 160, and end user computing device 170.

In one or more arrangements, enterprise computing platform 110, enterprise computing infrastructure 130, end user computing device 150, end user computing device 160, and end user computing device 170 may be any type of computing devices capable of receiving a user interface, receiving input via the user interface, and communicating the received input to one or more other computing devices. For example, enterprise computing platform 110, enterprise computing infrastructure 130, end user computing device 150, end user computing device 160, and end user computing device 170, and/or the other systems included in computing environment 100 may, in some instances, include one or more processors, memories, communication interfaces, display devices, storage devices, and/or other components. As noted above, and as illustrated in greater detail below, any and/or all of enterprise computing platform 110, enterprise computing infrastructure 130, end user computing device 150, end user computing device 160, and end user computing device 170 may, in some instances, be special-purpose computing devices configured to perform specific functions.

Referring to FIG. 1B, enterprise computing platform 110 may include one or more processor(s) 111 and memory(s) 112. A data bus may interconnect processor 111 and memory 112. Memory 112 may include one or more program modules having instructions that, when executed by processor 111, may cause enterprise computing platform 110 to perform one or more functions described herein and/or may cause one or more databases to store and/or otherwise maintain information which may be used by such program modules and/or processor 111. In some instances, the one or more program modules and/or databases may be stored and/or maintained in different memory units of enterprise computing platform 110 and/or by different computing devices that may form and/or otherwise make up enterprise computing platform 110. For example, memory 112 may have, store, and/or include a trust store 112a, an analytics engine 112b, an event store 112c, and a rule supply service 112d. Trust store 112a may be deployed and maintained to dynamically manage web browser extensions on end user computing devices, as discussed in greater detail below. Analytics engine 112b may deliver and store information used by trust store 112a and/or enterprise computing platform 110 in deploying and maintaining a trust store to dynamically manage web browser extensions on end user computing devices. Event store 112c may archive information received from end user computing devices (e.g., end user computing device 150) regarding the trust score used to manage web browser extensions on a particular end user computing device (e.g., end user computing device 150) as well as the determination by a web browser extension (e.g., web browser extension 152b) to either grant or deny the user request after evaluating the trust score. Rule supply service 112d may combine attributes collected from a web browser extension (e.g., web browser extension 152b) to generate the rules that the web browser extension (e.g., web browser extension 152b) may use to evaluate the trust score. Rule supply service 112d may also supply the web browser extension (e.g., web browser extension 152b) with the rules previously described as well as a trust threshold and a trust score threshold, both of which are described in detail below.

Referring to FIG. 1C, end user computing device 150 may include one or more processor(s) 151, memory(s) 152, communication interface(s) 153, and display device(s) 154. A data bus may interconnect processor 151, memory 152, communication interface 153, and display device 154. Communication interface 153 may be a network interface configured to support communication between end user computing device 150 and one or more networks (e.g., enterprise private network 120, public network 140, or the like). Memory 152 may include one or more program modules having instructions that, when executed by processor 151, may cause end user computing device 150 to perform one or more functions described herein and/or one or more databases to store and/or otherwise maintain information which may be used by such program modules and/or processor 151. In some instances, the one or more program modules and/or databases may be stored and/or maintained in different memory units of end user computing device 150. For example, memory 152 may have, store, and/or include a web browser 152a and a web browser extension 152b. Web browser 152a may house web browser extension 152b and may be used to access resources within enterprise computing infrastructure 130 and/or other resources (e.g., stored on various private and/or public websites). Web browser 152a may also display, using display device 154 of end user computing device 150, the resources requested by the user in the user request if web browser extension 152b grants the user request. Web browser extension 152b may evaluate the trust score pertaining to a particular user request to access resources located outside of the enterprise computing infrastructure 130 and may either grant or deny the user request depending on the evaluation of the trust score.

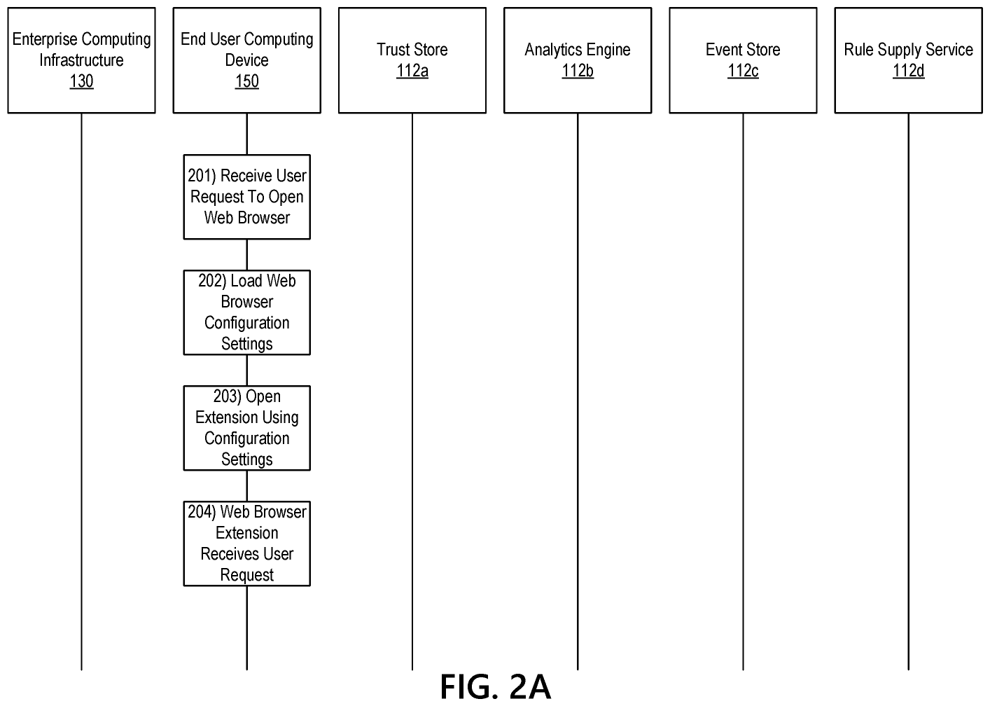

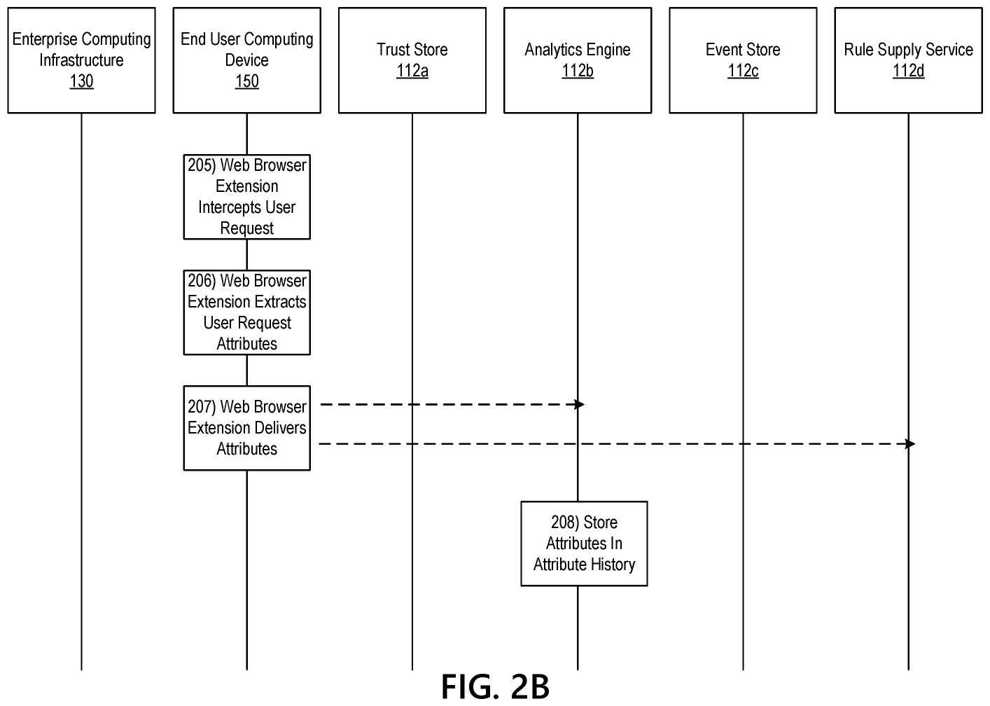

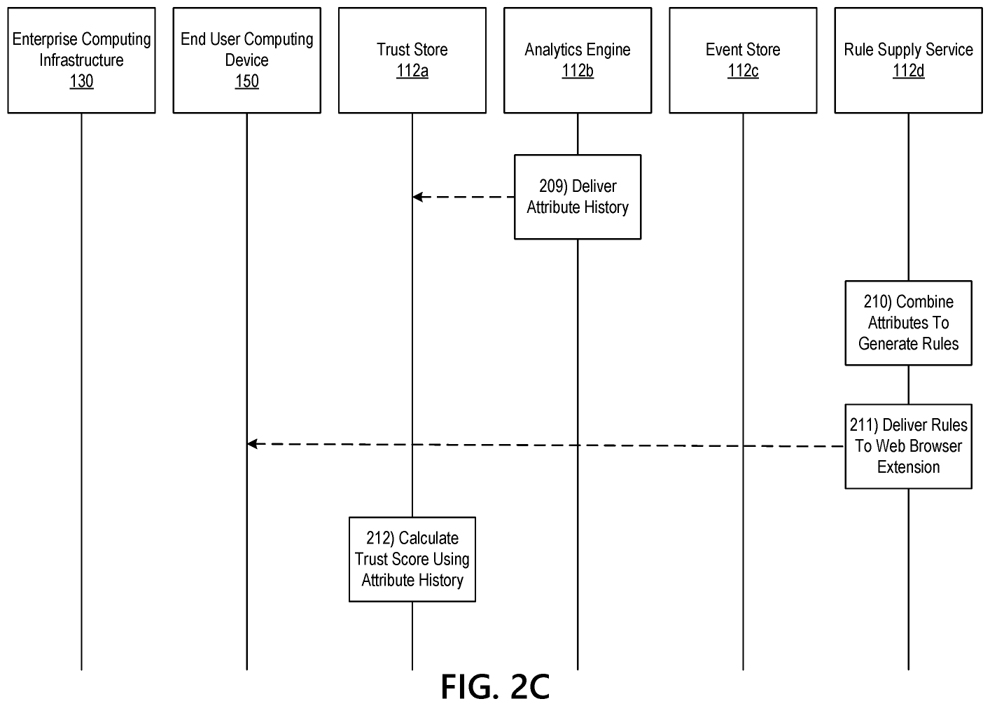

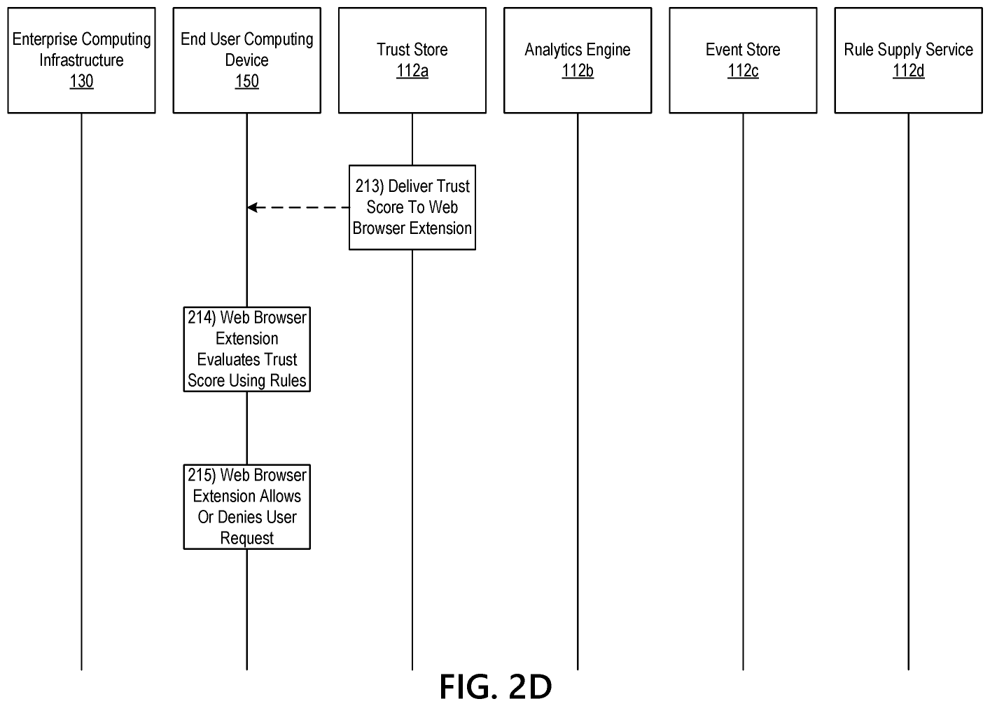

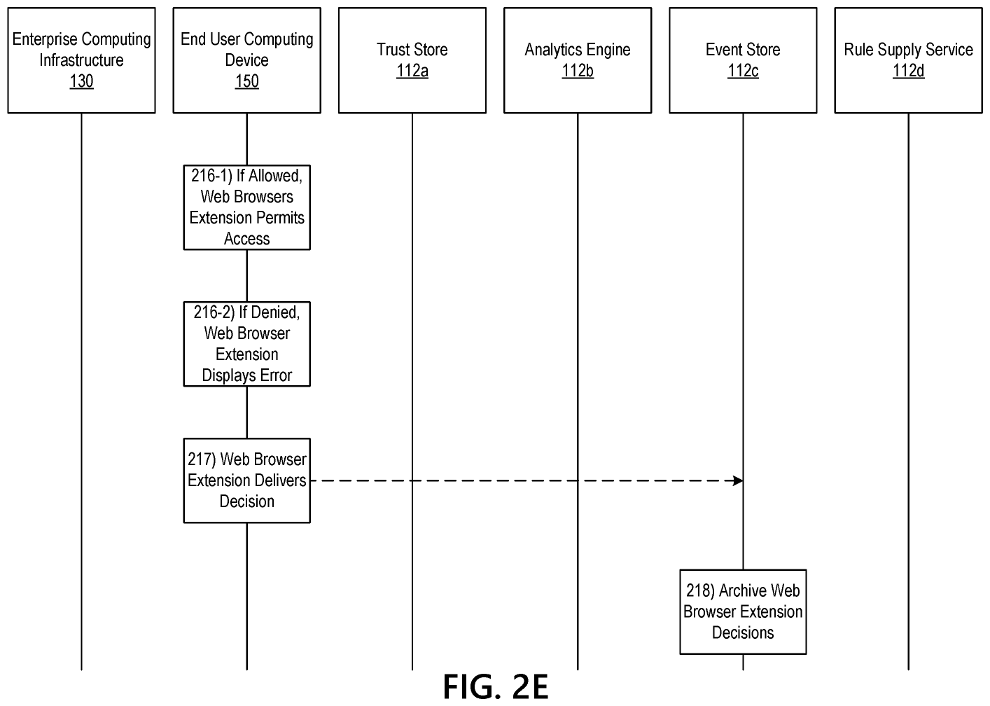

FIGS. 2A-2E depict an illustrative event sequence for deploying and maintaining a trust store to dynamically manage web browser extensions on end user computing devices in accordance with one or more example embodiments. Referring to FIG. 2A, at step 201, end user computing device 150 may receive a request from the user to open web browser 152a. Prior to entering a user request into a web browser extension 152b, a user must first access web browser 152a as web browser extension 152b may be embedded within web browser 152a. For example, to submit a user request to open web browser 152a, a user may manually select the web browser 152a application from the series of applications available on end user computing device 150. Web browser 152a may then be displayed on display device 154 of end user computing device 150, wherein the user may be able to access web browser extension 152b.

At step 202, end user computing device 150 may load the configuration settings and device management policies that may be required for execution of web browser extension 152b. Configuration settings and device management policies may refer to enterprise specific settings and policies that may be necessary to access resources located outside of enterprise computing infrastructure 130. For example, the configuration settings and device management policies may engage enterprise computing infrastructure 130 such that all enterprise resources that are available at and/or within a certain range of an enterprise location may become available for access by end user computing device 150. Moreover, the configuration settings and device management policies may engage enterprise computing platform 110 such that the modules and databases within memory 112 of enterprise computing platform 110 are prepared to process a user request from end user computing device 150.

At step 203, end user computing device 150 may use the configuration settings and device management policies from step 202 to load web browser extension 152b. Once loaded onto end user computing device 150, the configuration settings and device management policies from step 202 may enable web browser extension 152b, upon receipt of a user request, to process a user request using the steps described in detail below and to access resources located outside of enterprise computing infrastructure 130.

At step 204, end user computing device 150 may receive, by web browser extension 152b, a user request to access resources located outside of enterprise computing infrastructure 130. For example, after web browser 152a is displayed on display device 154 of end user computing device 150, the user may navigate to web browser extension 152b, which may be embedded within web browser 152a. Additionally or alternatively, the user may enter the request for resources located outside of enterprise computing infrastructure 130 into the web browser 152a associated with web browser extension 152b.

Referring to FIG. 2B, at step 205, web browser extension 152b may intercept the user request to access resources located outside of enterprise computing infrastructure 130. In addition to the content of the user request to access resources located outside of enterprise computing infrastructure 130, the user request intercepted by web browser extension 152b may contain a series of attributes. The attributes may be classified into three categories: user attributes; system attributes; and request attributes. The details of the attributes mentioned herein are discussed further below in connection with step 206.

At step 206, web browser extension 152b may extract and collect the user attributes, system attributes, and request attributes associated with the user request intercepted by web browser extension 152b. User attributes may provide information about the user who entered the request into web browser 152a associated with web browser extension 152b, using display device 154 of end user computing device 150, to access resources located outside of enterprise computing infrastructure 130. For example, user attributes may indicate, among other elements of information, the user's identity, the type of end user computing device 150 through which the user submitted the request to access resources located outside of enterprise computing infrastructure 130, the user's authorization clearance within the enterprise (e.g., whether the enterprise has restricted the level and the type of resource that a user may request), whether the user has requested the same or similar resources in the past, and whether web browser extension 152b granted or denied the user's previous requests. System attributes may provide information about end user computing device 150, on which the user may submit the request to access resources located outside of enterprise computing infrastructure 130. For example, system attributes may indicate, among other elements of information, the geographic location of end user computing device 150, whether the user has previously used end user computing device 150 to submit requests to access resources located outside of enterprise computing infrastructure 130, and the method of connection used to submit the user request on end user computing device 150 (e.g., a wireless connection on a secure, private network, or a wireless connection on a public network in a public area). Request attributes may indicate, among other elements of information, whether the user has surpassed a daily allowance for submitting requests of the same kind, whether the timing of the user's present request matches that of previous requests, whether the location of end user computing device 150 used to submit the present request matches the location of end user computing device 150 used to submit previous requests, and whether the connection method of end user computing device 150 used to submit the present request matches the connection method of end user computing device 150 used to submit previous requests.

At step 207, web browser extension 152b may deliver the user attributes, system attributes, and request attributes to enterprise computing platform 110. More specifically, web browser extension 152b may deliver the user attributes, system attributes, and request attributes extracted from the user request to analytics engine 112b and rule supply service 112d in memory 112 of enterprise computing platform 110. Analytics engine 112b may create and maintain an attribute history. The attribute history may be an archive of all user attributes, system attributes, and request attributes delivered to enterprise computing platform 110 that are associated with previous user requests. Analytics engine 112b may directly communicate with web browser extension 152b to ensure the user attributes, system attributes, and request attributes of the present user request, which may be extracted and collected by web browser extension 152b, may be archived within the attribute history. Rule supply service 112d may be responsible for generating rules that may be used by web browser extension 152b to evaluate the trust score, as described in detail below.

At step 208, analytics engine 112b may store the user attributes, system attributes, and request attributes related to the present user request to access resources located outside of enterprise computing infrastructure 130 in the attribute history of analytics engine 112b. Once in the attribute history, the present user attributes, system attributes, and request attributes may be added to all user attributes, system attributes, and request attributes of previous user requests.

Referring to FIG. 2C, at step 209, analytics engine 112b may deliver the attribute history to trust store 112a. Trust store 112a may be deployed and maintained to dynamically manage web browser extensions on end user computing devices. Trust store 112a may be responsible for generating a trust score that web browser extension 152b may use to evaluate the present user request. A trust score may indicate whether the present user request is a legitimate request to access resources located outside of enterprise computing infrastructure 130. To calculate the trust score, trust store 112a may require the user attributes, system attributes, and request attributes of the present request (discussed in step 206) and the attribute history from analytics engine 112b (discussed in step 208). Trust store 112a may compare the attributes of the present request to the attributes listed in the attribute history. If the attributes of the present request are substantially similar to the attributes in the attribute history, trust store 112a may return a high trust score. A high trust score may indicate that the present user request is substantially similar to prior user requests, thus increasing the legitimacy of the present user request. For example, if the attribute history indicates, among other things, that the user routinely submits a request similar to the present user request at the same time every day, then trust store 112a may return a high trust score. However, if the attributes of the present request are not substantially similar to the attributes in the attribute history, trust store 112a may return a low trust score. A low trust score may indicate that the present user request is not substantially similar to prior user requests, thus decreasing the legitimacy of the present user request.

At step 210, rule supply service 112d may combine the user attributes, system attributes, and request attributes of the present user request with the attributes listed in the attribute history of analytics engine 112b to generate rules that web browser extension 152b may use to evaluate the trust score. Rule supply service 112d may use the attribute history to establish a trust threshold. For example, if the attribute history shows that the user routinely requests a particular resource during morning hours, but the present user request was not submitted during morning hours, then the timing of the present user request may fall below the trust threshold. If analysis of a particular attribute falls below the trust threshold, the rule from rule supply service 112d may dictate that the trust score be adjusted accordingly. However, if the attributes of the present request are substantially similar to the attributes listed in the attribute history, then the present user request may not fall below the trust threshold. Subsequently, if the attributes of the present request are substantially similar to the attributes listed in the attribute history, the trust score may remain unchanged. Rule supply service 112d may generate rules to analyze user attributes, system attributes, and request attributes such that each attribute that was extracted and collected by web browser extension 152b in step 206 may be evaluated.

At step 211, rule supply service 112d may deliver the rules generated in step 210 to web browser extension 152b. Web browser extension 152b may use the rules to evaluate the trust score, described in detail below.

At step 212, trust store 112a may calculate the trust score using the attribute history from analytics engine 112b. As discussed in step 209, trust store 112a may generate a trust score that web browser extension 152b may use to evaluate the present user request. To calculate the trust score, trust store 112a may require the user attributes, system attributes, and request attributes of the present request (discussed in step 206) and the attribute history from analytics engine 112b (discussed in step 208). Trust store 112a may compare the attributes of the present request to the attributes listed in the attribute history. If the attributes of the present request are substantially similar to the attributes in the attribute history, trust store 112a may return a high trust score. A high trust score may indicate that the present user request is substantially similar to prior user requests, thus increasing the legitimacy of the present user request. For example, if the attribute history indicates, among other things, that the user routinely submits a request similar to the present user request at the same time every day, then trust store 112a may return a high trust score. However, if the attributes of the present request are not substantially similar to the attributes in the attribute history, trust store 112a may return a low trust score. A low trust score may indicate that the present user request is not substantially similar to prior user requests, thus decreasing the legitimacy of the present user request.

Referring to FIG. 2D, at step 213, trust store 112a may deliver the trust score to web browser extension 152b. Web browser extension 152b may require the trust score since web browser extension 152b may be responsible for determining whether to grant or to deny the user request to access resources located outside of enterprise computing infrastructure 130.

At step 214, web browser extension 152b may evaluate the trust score using rules from rule supply service 112d. The rules generated by rule supply service 112d may be a combination of user attributes, system attributes, and request attributes of the present request and the attributes listed in the attribute history. When evaluating the trust score, web browser extension 152b may first retrieve the trust threshold from the rule supply service 112d. The trust threshold may indicate the trust score that the user request may either meet or surpass for web browser extension 152b to grant the user request. Web browser extension 152b may then evaluate each of user attributes, system attributes, request attributes, which were extracted from the user request by web browser extension 152b in step 206, using the rules from rule supply service 112d. For example, a rule may dictate that the user routinely requests a particular resource during morning hours, but the attributes of the present user request may indicate that the present user request was not submitted during morning hours. As such, the timing of the user request may fall below the trust threshold. When a particular attribute fails to meet the trust threshold, the rule from rule supply service 112d may dictate that the trust score be adjusted accordingly. Namely, that the trust score may be reduced. Therefore, in the present example, if a user routinely requests a particular resource during morning hours, but the request attributes indicate that the present user request was not submitted during morning hours, then the trust score may be reduced. However, if the user routinely requests a particular resource during morning hours and the present user request was also submitted during morning hours, then the trust threshold may remain satisfied. As such, the trust score may remain unchanged and web browser extension 152b may proceed with evaluating the remaining attributes. Web browser extension 152b may continue evaluating each attribute using the trust threshold until all attributes have been evaluated using rules from rule supply service 112d. When web browser extension 152b has evaluated each attribute, web browser extension 152b may return a final trust score, which may be used by web browser extension 152b in step 215 to determine whether to grant or to deny the user request to access resources located outside of enterprise computing infrastructure 130.

At step 215, web browser extension 152b may use the final trust score from step 214 to determine whether to grant or to deny the user request to access resources located outside of enterprise computing infrastructure 130. In doing so, web browser extension 152b may consider a second threshold generated by rule supply service 112d. This second threshold may indicate the minimum trust score that a user request may achieve for web browser extension 152b to grant the user request to access resources located outside of enterprise computing infrastructure 130. If the final trust score, discussed in step 214, falls below this second threshold, then web browser extension 152b may deny the user request to access resources located outside of enterprise computing infrastructure 130. However, if the final trust score, discussed in step 214, meets or surpasses this second threshold, then web browser extension 152b may grant the user request to access resources located outside of enterprise computing infrastructure 130.

Referring to FIG. 2E, at step 216, web browser extension 152b may undertake one of two possible courses of action depending on the decision that web browser extension 152b returns in step 215. In particular, if web browser extension 152b determines to grant the user request at step 215, then at step 216-1, web browser extension 152b may grant the user request to access resources located outside of enterprise computing infrastructure 130. In doing so, web browser 152a associated with web browser extension 152b may retrieve the content of the user request to access resources located outside of enterprise computing infrastructure 130. In addition to retrieving the content of the user request, web browser 152a associated with web browser extension 152b may display the requested resources using display device 154 of end user computing device 150 such that the user may engage with the requested resources.

Alternatively, if web browser extension 152b determines to deny the user request at step 215, then at step 216-2, web browser extension 152b may deny the user request to access resources located outside of enterprise computing infrastructure 130. In doing so, web browser extension 152b may generate an error message indicating that web browser extension 152b denied the user's request to access resources located outside of enterprise computing infrastructure 130. Web browser 152a associated with web browser extension 152b may display the error message using display device 154 of end user computing device 150 to inform the user that the request has been denied.

At step 217, web browser extension 152b may deliver the decision to either grant or deny the user request, rendered in step 215, to event store 112c. Event store 112c may archive information received from end user computing device 150 regarding the trust score used by web browser extension 152b to determine whether to grant or to deny the user request to access resources located outside of enterprise computing infrastructure 130. Event store 112c may also archive the decision by web browser extension 152b to either grant or to deny the user request to access resources located outside of enterprise computing infrastructure 130.

At step 218, event store 112c may archive the trust score of the present user request and the decision rendered by web browser extension 152b with respect to the present user request. Both the trust score of the present user request and the decision rendered by web browser extension 152b with respect to the present user request may be used in future iterations of the decision-making process described herein. For example, if the user submits a new request that is identical to a previous request, event store 112c may access the trust score associated with the previous request and the decision rendered by web browser extension 152b with respect to the previous user request. The information related to the previous user request may be used to inform web browser extension 152b how to proceed regarding the present user request.

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored as computer-readable instructions on a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, application-specific integrated circuits (ASICs), field programmable gate arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an enterprise computing platform, or as one or more non-transitory computer-readable media storing instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space).

As described herein, the various methods and acts may be operative across one or more computing servers and one or more networks. The functionality may be distributed in any manner, or may be located in a single computing device (e.g., a server, a client computer, and the like). For example, in alternative embodiments, one or more of the computing platforms discussed above may be combined into a single computing platform, and the various functions of each computing platform may be performed by the single computing platform. In such arrangements, any and/or all of the above-discussed communications between computing platforms may correspond to data being accessed, moved, modified, updated, and/or otherwise used by the single computing platform. Additionally or alternatively, one or more of the computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, and one or more depicted steps may be optional in accordance with aspects of the disclosure.

What is claimed is:

1. A method comprising:
at an enterprise computing platform comprising at least one processor, memory, and a communication interface:
receiving, by the at least one processor, from a web browser extension associated with an end user computing device, user attributes, system attributes, and request attributes associated with a user request;
generating, by the at least one processor, a trust score using the user attributes, the system attributes, and the request attributes received from the web browser extension associated with the end user computing device, wherein generating the trust score using the user attributes, the system attributes, and the request attributes associated with the user request received from the web browser extension associated with the end user computing device comprises:
receiving, by the at least one processor, from an attribute history archive on the enterprise computing platform, the user attributes, the system attributes, and the request attributes;
comparing, by the at least one processor, the user attributes, the system attributes, and the request attributes associated with the user request to the user attributes, the system attributes, and the request attributes stored in the attribute history archive on the enterprise computing platform; and
generating, by the at least one processor and based on the comparing, the trust score; and
sending, by the at least one processor, to the web browser extension associated with the end user computing device, the trust score;
wherein sending the trust score to the web browser extension associated with the end user computing device causes the web browser extension associated with the end user computing device to allow or deny the user request based on the trust score.

2. The method of claim 1, wherein receiving the user attributes, the system attributes, and the request attributes from the web browser extension associated with the end user computing device comprises receiving the user attributes, the system attributes, and the request attributes from an extension that executes on the end user computing device and that is configured to intercept user requests and collect attributes associated with the intercepted user requests.

3. The method of claim 2, wherein the user attributes, the system attributes, and the request attributes associated with the user request are stored in an attribute history archive on the enterprise computing platform.

4. The method of claim 1, wherein sending the trust score to the web browser extension associated with the end user computing device causes the web browser extension to evaluate the trust score using rules generated by the enterprise computing platform.

5. The method of claim 4, wherein causing the web browser extension to evaluate the trust score using the rules generated by the enterprise computing platform comprises:
causing the web browser extension associated with the end user computing device to determine whether the user attributes, the system attributes, and the request attributes associated with the user request satisfy the rules generated by the enterprise computing platform; and
causing the web browser extension associated with the end user computing device to adjust the trust score based on determining whether the user attributes, the system attributes, and the request attributes associated with the user request satisfy the rules generated by the enterprise computing platform.

6. The method of claim 5, wherein causing the web browser extension associated with the end user computing device to adjust the trust score comprises causing the web browser extension associated with the end user computing device to reduce the trust score if the user attributes, the system attributes, and the request attributes associated with the user request fail to satisfy the rules.

7. The method of claim 4, wherein the rules generated by the enterprise computing platform are generated based on information corresponding to:
location of the end user computing device,
user behavior,
IP address,
resources listed in the user request, and
unique identifiers that are used to connect to a network.

8. The method of claim 4, wherein causing the web browser extension to evaluate the trust score using the rules generated by the enterprise computing platform comprises:
causing the web browser extension associated with the end user computing device to permit access to the resources listed in the user request if the trust score is above a threshold; and
causing the web browser extension associated with the end user computing device to deny access to the resources listed in the user request if the trust score is below a threshold.

9. An enterprise computing platform comprising:
at least one processor;
a communication interface; and
memory storing computer-readable instructions that, when executed by the at least one processor, cause the enterprise computing platform to:
receive, from a web browser extension associated with an end user computing device, user attributes, system attributes, and request attributes associated with a user request;
generate a trust score using the user attributes, the system attributes, and the request attributes received from the web browser extension associated with the end user computing device, wherein generating the trust score using the user attributes, the system attributes, and the request attributes associated with the user request received from the web browser extension associated with the end user computing device comprises:
receiving, by the at least one processor, from an attribute history archive on the enterprise computing platform, the user attributes, the system attributes, and the request attributes;
comparing, by the at least one processor, the user attributes, the system attributes, and the request attributes associated with the user request to the user attributes, the system attributes, and the request attributes stored in the attribute history archive on the enterprise computing platform; and
generating, by the at least one processor and based on the comparing, the trust score; and
send, to the web browser extension associated with the end user computing device, the trust score;
wherein sending the trust score to the web browser extension associated with the end user computing device causes the web browser extension associated with the end user computing device to allow or deny the user request based on the trust score.

10. The enterprise computing platform of claim 9, wherein receiving the user attributes, the system attributes, and the request attributes from the web browser extension associated with the end user computing device comprises receiving the user attributes, the system attributes, and the request attributes from an extension that executes on the end user computing device and that is configured to intercept user requests and collect attributes associated with the intercepted user requests.

11. The enterprise computing platform of claim 10, wherein the user attributes, the system attributes, and the request attributes associated with the user request are stored in an attribute history archive on the enterprise computing platform.

12. The enterprise computing platform of claim 9, wherein sending the trust score to the web browser extension associated with the end user computing device causes the web browser extension to evaluate the trust score using rules generated by the enterprise computing platform.

13. The enterprise computing platform of claim 12, wherein causing the web browser extension to evaluate the trust score using the rules generated by the enterprise computing platform comprises:
causing the web browser extension associated with the end user computing device to determine whether the user attributes, the system attributes, and the request attributes associated with the user request satisfy the rules generated by the enterprise computing platform; and
causing the web browser extension associated with the end user computing device to adjust the trust score based on determining whether the user attributes, the system attributes, and the request attributes associated with the user request satisfy the rules generated by the enterprise computing platform.

14. The enterprise computing platform of claim 13, wherein causing the web browser extension associated with the end user computing device to adjust the trust score comprises causing the web browser extension associated with the end user computing device to reduce the trust score if the user attributes, the system attributes, and the request attributes associated with the user request fail to satisfy the rules.

15. The enterprise computing platform of claim 12, wherein the rules generated by the enterprise computing platform are generated based on information corresponding to:
location of the end user computing device,
user behavior,
IP address,
resources listed in the user request, and
unique identifiers that are used to connect to a network.

16. The enterprise computing platform of claim 12, wherein causing the web browser extension to evaluate the trust score using the rules generated by the enterprise computing platform comprises:
causing the web browser extension associated with the end user computing device to permit access to the resources listed in the user request if the trust score is above a threshold; and
causing the web browser extension associated with the end user computing device to deny access to the resources listed in the user request if the trust score is below a threshold.

17. One or more non-transitory computer-readable media storing instructions that, when executed by an enterprise computing platform comprising at least one processor, memory, and a communication interface, cause the enterprise computing platform to:
receive, from a web browser extension associated with an end user computing device, user attributes, system attributes, and request attributes associated with a user request;
generate a trust score using the user attributes, the system attributes, and the request attributes received from the web browser extension associated with the end user computing device, wherein generating the trust score using the user attributes, the system attributes, and the request attributes associated with the user request received from the web browser extension associated with the end user computing device comprises:
receiving, by the at least one processor, from an attribute history archive on the enterprise computing platform, the user attributes, the system attributes, and the request attributes;
comparing, by the at least one processor, the user attributes, the system attributes, and the request attributes associated with the user request to the user attributes, the system attributes, and the request attributes stored in the attribute history archive on the enterprise computing platform; and
generating, by the at least one processor and based on the comparing, the trust score; and
send, to the web browser extension associated with the end user computing device, the trust score;
wherein sending the trust score to the web browser extension associated with the end user computing device causes the web browser extension associated with the end user computing device to allow or deny the user request based on the trust score.

18. The one or more non-transitory computer-readable media of claim 17, wherein receiving the user attributes, the system attributes, and the request attributes from the web browser extension associated with the end user computing device comprises receiving the user attributes, the system attributes, and the request attributes from an extension that executes on the end user computing device and that is configured to intercept user requests and collect attributes associated with the intercepted user requests.

19. The one or more non-transitory computer-readable media of claim 18, wherein the user attributes, the system attributes, and the request attributes associated with the user request are stored in an attribute history archive on the enterprise computing platform.

20. The one or more non-transitory computer-readable media of claim 17, wherein sending the trust score to the web browser extension associated with the end user computing device causes the web browser extension to evaluate the trust score using rules generated by the enterprise computing platform.
